(19) United States
(12) Patent Application Publication
(10) Pub. No.: US 2026/0312420 A1
(43) Pub. Date: Oct. 8, 2026

(54) CIRCUIT FOR PROVIDING ELECTRICAL ENERGY FROM A RECHARGEABLE BATTERY TO A LOAD

(71) Applicant: Vestel Elektronik Sanayi ve Ticaret A.S., Manisa (TR)

(72) Inventor: Ali AGCABAY, Manisa (TR)

(21) Appl. No.: 18/880,715

(22) PCT Filed: Jul. 5, 2022
(86) PCT No.: PCT/EP2022/068568

§ 371 Date: Jan. 2, 2025

(51) Int. Cl. H02J 7/00; H02J 7/68; H02J 9/06

(52) U.S. Cl. CPC H02J 7/865; H02J 7/68; H02J 7/855; H02J 9/061; H02J 2207/20

(57) ABSTRACT

A circuit for providing electrical energy from a rechargeable battery to a load and for controlling charging of the rechargeable battery is disclosed. The circuit has first and second battery connectors for connection to terminals of the battery. The circuit has first and second load connectors for connection to the load and to a source of electrical energy such that the load and the source of electrical energy are connected to the same load connectors. A voltage control circuit controls operation of a charger circuit by comparing a voltage difference between the first and second load connectors with a threshold. The voltage control circuit controls the charger circuit to output electrical energy to charge the battery if the voltage difference is greater than the threshold, and controls the charger circuit not to output electrical energy to charge the battery if the voltage difference is less than the threshold.

### TECHNICAL FIELD

The present disclosure relates to a circuit for providing electrical energy from a rechargeable battery to a load.

### BACKGROUND

It is often desirable to connect multiple batteries in series in order to provide a higher voltage than provided by a single battery. It is also often desirable to connect multiple batteries in parallel in order to provide a higher current output and a greater capacity (e.g. total amp hours) than provided by a single battery. However, if the outputs of the batteries are connected in parallel, at least one battery will be a drain on a second battery if the voltage output by the first battery is lower than the voltage output of the second battery as the second battery will charge the first battery.

To deal with this, it is known to use diodes to prevent current passing from one battery to another. However, in the case that the batteries are rechargeable batteries, this requires that there is a first connection from the batteries to the load which is being powered by the batteries and a second connection to the batteries from a power source which recharges the batteries (and optionally powers the load).

As an alternative, control circuits may be provided for controlling charging and discharge of the batteries. Such control circuits are typically controlled via control signals communicated via a System Management Bus (SMBus) according to a specified protocol. However, this adds to the complexity and cost and also places a limit on the number of batteries that can be connected in parallel.

Further, known systems of this type typically limit the current that can be used to charge plural batteries simultaneously. Another issue is that known systems require software control, which can be relatively slow to adapt to loss of mains power to the load. This is a particular problem if the batteries are intended to provide a back-up power supply. In addition, if one battery fails or goes into a protection state, this can mean that communication is not possible with other batteries, especially other batteries that are downstream of the battery that fails.

### SUMMARY

According to an aspect disclosed herein, there is provided a circuit for providing electrical energy from a rechargeable battery connected in use to the circuit to a load connected in use to the circuit and for controlling charging of the rechargeable battery, the circuit comprising:
a first battery connector for electrical connection to a first terminal of a rechargeable battery connected in use to the circuit;
a second battery connector for electrical connection to a second terminal of said rechargeable battery;
a first load connector for electrical connection to a first terminal of a load connected in use to the circuit and to a first terminal of a source of electrical energy connected in use to the circuit;
a second load connector for electrical connection to a second terminal of said load and to a second terminal of said source of electrical energy;
whereby said load and said source of electrical energy are connected to the same load connectors of the circuit;
a charger circuit for receiving electrical energy from said source of electrical energy and outputting the electrical energy to charge said rechargeable battery;

a voltage control circuit constructed and arranged to control operation of the charger circuit by comparing a voltage difference between the first load connector and the second load connector with a threshold, wherein the voltage control circuit is constructed and arranged to control the charger circuit to operate to output electrical energy to charge said rechargeable battery if the voltage difference between the first load connector and the second load connector is greater than the threshold, and wherein the voltage control circuit is constructed and arranged to control the charger circuit not to output electrical energy to charge said rechargeable battery if the voltage difference between the first load connector and the second load connector is less than the threshold.

In an example, the circuit comprises a switch in the discharge path from said rechargeable battery to one of the load connectors to control discharge of said rechargeable battery to said load and charging of said rechargeable battery, wherein the voltage control circuit is constructed and arranged such that if the voltage difference between the first load connector and the second load connector is less than the threshold, the voltage control circuit causes the switch to be operated either (i) to allow discharge of said rechargeable battery to said load and to allow charging of said rechargeable battery by said source of electrical energy via the switch or (ii) to allow discharge of said rechargeable battery to said load and to block charging of said rechargeable battery by said source of electrical energy via the switch.

In an example, the switch is an N-channel MOSFET, and the circuit comprises a high side FET drive circuit which is enabled by the voltage control circuit to operate the N-channel MOSFET to allow discharge of said rechargeable battery to said load and to allow charging of said rechargeable battery by said source of electrical energy via the N-channel MOSFET when the voltage difference between the first load connector and the second load connector is less than the threshold.

In an example, the switch is an N-channel MOSFET, and the circuit comprises an ideal diode controller which is enabled by the voltage control circuit to operate the N-channel MOSFET to allow discharge of said rechargeable battery to said load and to block charging of said rechargeable battery by said source of electrical energy via the N-channel MOSFET.

In an example, the circuit comprises at least one of a toggle switch and jumpers which can be operated to select whether the voltage control circuit enables the high side FET drive circuit or the ideal diode controller to operate the N-channel MOSFET when the voltage difference between the first load connector and the second load connector is less than the threshold.

In an example, the voltage control circuit comprises a comparator circuit which comprises two transistor shunt regulators, the transistor shunt regulators being constructed and arranged to output enable signals to control operation of the charger circuit and the switch in the discharge path from said rechargeable battery to said load.

In an example, the charger circuit is connected to said rechargeable battery via a diode which permits electrical energy to pass from the charger circuit to said rechargeable battery to allow said rechargeable battery to be charged by the charger circuit and which prevents electrical energy passing from said rechargeable battery to the charger circuit when said rechargeable battery is discharging.

In an example, the charger circuit is a synchronous buck converter which is arranged to receive electrical energy from said source of electrical energy at a first voltage and output the electrical energy at a second voltage to charge said rechargeable battery.

In an example, the circuit comprises a battery management control unit for control of said rechargeable battery, wherein the electrical connections of the circuit to the first and second terminals of said rechargeable battery are via the battery management control unit.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a prior art circuit that uses diodes to prevent current passing from one battery to another;

FIG. 2 shows schematically an example of a prior art circuit that uses control circuits to control charging and discharge of the batteries;

FIGS. 3A and 3B show schematically an example of a prior art circuit that uses a controller to control charging and discharge of the batteries;

FIG. 4 shows schematically an example of a circuit for providing electrical energy from a rechargeable battery to a load according to an embodiment of the present disclosure; and

FIG. 5 shows schematically an example of a voltage control circuit of the circuit of FIG. 4.

### DETAILED DESCRIPTION

As background and as mentioned, it is often desirable to connect multiple batteries in series in order to provide a higher voltage than provided by a single battery. It is also often desirable to connect multiple batteries in parallel in order to provide a higher current output and a greater capacity (e.g. total amp hours) than provided by a single battery. However, in practice, the output voltages of different batteries will differ even if they are nominally the same. This voltage difference between the batteries means that if the outputs of the batteries are connected in parallel, a first battery will be a drain on a second battery if the voltage output by the first battery is lower than the voltage output of the second battery as the second battery will charge the first battery. This prematurely drains the second battery. Also, if the internal resistance of the batteries is low, as is particularly the case with batteries that use lithium ion chemistry, the current that flows from one battery to the other will be quite high, which can cause one or both of the batteries to overheat, damaging the battery and presenting a fire risk.

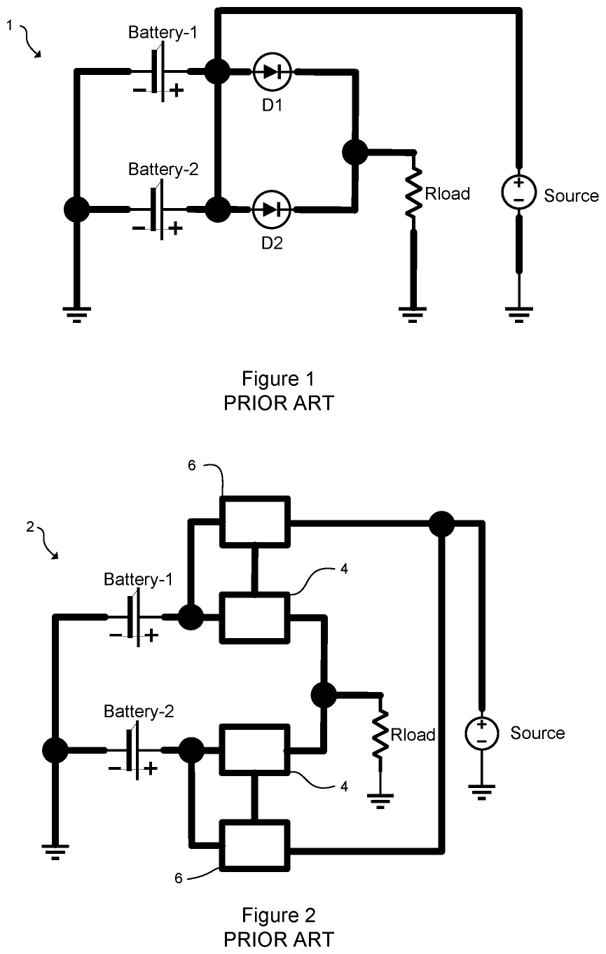

To deal with this, it is known to use diodes to prevent current passing from one battery to another. An example of a circuit 1 of this type is shown schematically in FIG. 1. Two batteries Battery-1 and Battery-2 are connected in parallel to a load, shown schematically as a resistance Rload. Diodes D1 and D2 are placed in series between the batteries Battery-1 and Battery-2 and the load Rload. The diodes D1 and D2 allow the batteries Battery-1 and Battery-2 to discharge current to the load Rload and prevent current passing from one battery to the other. However, because the didoes prevent current passing along the discharge line to the load Rload, if the batteries are rechargeable batteries and are recharged from a power source, then a separate connection to the batteries from the power source must be provided. That is, there is a first connection from the batteries to the load Rload which is being powered by the batteries and a second connection to the batteries from a power source which recharges the batteries. This adds to the cost and complexity of the circuit. This is particularly problematic in the case that the power source which recharges the batteries also powers the load, with the batteries Battery-1 and Battery-2 providing a back-up power supply for the load Rload in case power from the power source is lost or removed for some reason.

As an alternative, control circuits may be provided for controlling charging and discharge of the batteries. An example of a circuit 2 of this type is shown schematically in FIG. 2. Each of the batteries Battery-1 and Battery-2 is connected to the load Rload via a respective active circuit element 4 in series. Each active circuit element 4 is respectively controlled by a respective control circuit 6. The control circuits 6 control the respective active circuit elements 4 to prevent one battery charging the other, by for example maintaining a positive voltage difference above a respective threshold between their respective cell voltage and the load voltage. Such a circuit 2 may be of benefit over a circuit that uses diodes like the circuit 1 of FIG. 1 in the case that the battery cell voltage is near the operating voltage of the load. This is because the forward voltage drop of the diodes of the circuit 1 of FIG. 1 may be too high for some circuits, and the electronics will not work properly because the lower limit of operating voltage has been reached or exceeded. Nevertheless, the circuit of FIG. 2 still requires a separate connection to the batteries from the power source in order to be able to recharge the batteries.

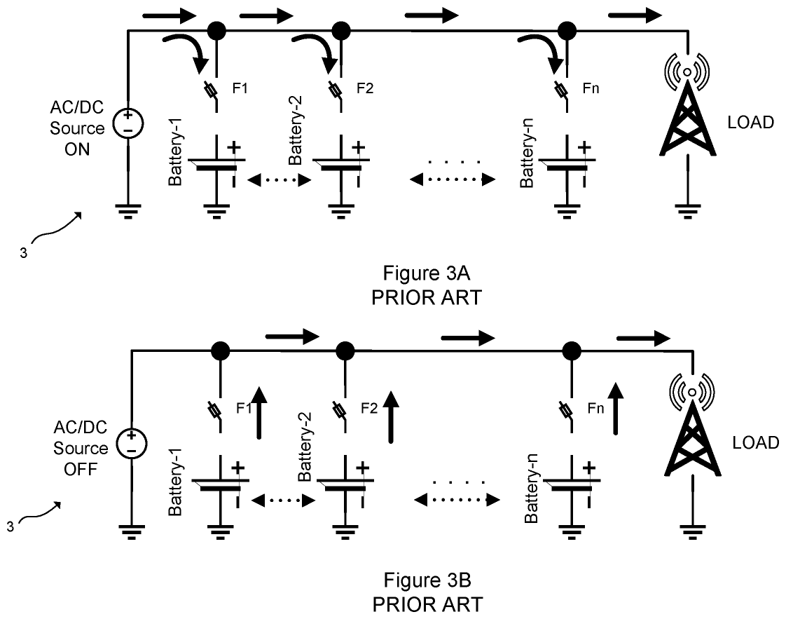

FIGS. 3A and 3B show schematically an example of a prior art circuit 3 that uses a controller to control charging and discharge of the batteries. The circuit 3 is a relatively sophisticated system in which the batteries provide back-up in case of loss of power from a power supply, such as a mains (grid) power supply AC/DC source. Such circuits 3 may be used in for example residential or commercial back-up power supplies, at cellular network base stations, network and computer centres, etc. FIGS. 3A and 3B show plural batteries Battery-1, Battery-2, . . . , Battery-n connected in parallel to a load.

In FIG. 3A, a power source AC/DC source, such as a mains (grid) power supply, is on and providing electrical energy to the load LOAD. In addition, the power source can recharge the batteries. The power source generally works in a constant current/constant voltage mode to be able to charge the batteries from the grid. The flow of electrical energy (or current) is indicated schematically by arrows. Each battery is connected to the power source via a switch F1, F2, etc. The switches may be transistors, such as for example FETs. The switches are controlled to be on or off so that only one battery is charged at any particular instant of time. When a particular battery is fully charged, its switch is turned off and the switch for another battery is turned on to allow that other battery to be charged.

In FIG. 3B, the power source is off (because for example there has been a loss of power from the grid). In this case, the switches F1, F2, etc. are controlled so that one and only one battery provides electrical energy to the load at any particular time. When that battery has discharged, its switch is turned off and the switch for another battery is turned on so that that battery can power the load.

The system of FIGS. 3A and 3B has a control unit system for controlling operation of the switches. In one example, the control unit system must sense the grid voltage and also the stability of the grid electricity supply. Alternatively or additionally, the batteries may communicate with each other, in a daisy-chain communication system indicated schematically by arrows with dotted lines. This may be used so that one battery causes another battery to go into a protection state, such that it does not supply power, if both batteries were supply power at the same time, which prevents too high a current being provided to the load.

As will be understood, in order to ensure that the load continuously receives power in the case that the power from the grid is lost, it is critical in a system like that shown in FIGS. 3A and 3B that the switches of the batteries are controlled so that as a battery is switched off, another battery is switched on at exactly the same time. This complicates the control of the switches. For example, the timing of the control signals to the switches becomes important and it can also be necessary to account for the switching time of the switch driver circuits. The length of the signal communication lines to the batteries and the switches can also be a factor in introducing (unknown) delays in the switches being turned on and off. Further, the addressing protocol and maximum baud rate used in communication systems of the type used in battery circuits like that shown in FIGS. 3A and 3B can limit the maximum number of batteries that can be addressed to for example 16 or 32. Finally, especially in the case that the batteries communicate directly with each other in a daisy-chain manner, if one battery fails or goes into a protection state, it may not be possible for communications to pass to further batteries down the chain.

Examples of the present disclosure enable plural rechargeable batteries to be connected to a load and to a power supply source using the same line, with the batteries not being able to discharge to each other even if their output voltages are different. In an example, the plural rechargeable batteries can be connected in parallel to the load and to the power supply source using the same line. This is achieved in some examples without the need for software control for switching the outputs of the batteries for equalization of the outputs or switching the outputs of the batteries with control sequences or signals, and avoiding the need for communication between the batteries. Examples described herein provide a circuit for each battery, the circuit having an on-board charger circuit and voltage level sensing for the battery. Some examples described herein enable parallel charging of batteries at different charging currents. In some examples described herein, there is no need to control the output voltages of the batteries individually, and there is no need for communication with the batteries by a central controller or for communication between the batteries. This means that in principle there is no limit on the number of batteries that can be connected.

In an example, for a particular rechargeable battery, this is achieved by providing a charger circuit, which receives electrical energy from a source of electrical energy and outputs the electrical energy to charge the battery. Further, a voltage control circuit which controls operation of the charger circuit is provided. The voltage control circuit compares a voltage difference between a first load connector and a second load connector with a threshold. The voltage control circuit controls the charger circuit to operate to output the electrical energy to charge the rechargeable battery if the voltage difference is greater than the threshold, and the voltage control circuit controls the charger circuit not to output electrical energy to charge the rechargeable battery if the voltage difference is less than the threshold.

In an example, the circuit comprises a switch in the discharge path from the rechargeable battery to one of the load connectors to control discharge of said rechargeable battery to said load and charging of said rechargeable battery. If the voltage difference between the first load connector and the second load connector is less than the threshold, the voltage control circuit causes the switch to be operated either (i) to allow discharge of said rechargeable battery to said load and to allow charging of said rechargeable battery by said source of electrical energy via the switch or (ii) to allow discharge of said rechargeable battery to said load and to block charging of said rechargeable battery by said source of electrical energy via the switch.

In an example, the voltage control circuit comprises a comparator circuit which comprises two transistor shunt regulators and which outputs enable signals to control operation of the charger circuit and a switch in the discharge path from the rechargeable battery to the load to control charging of the battery and discharge by the battery.

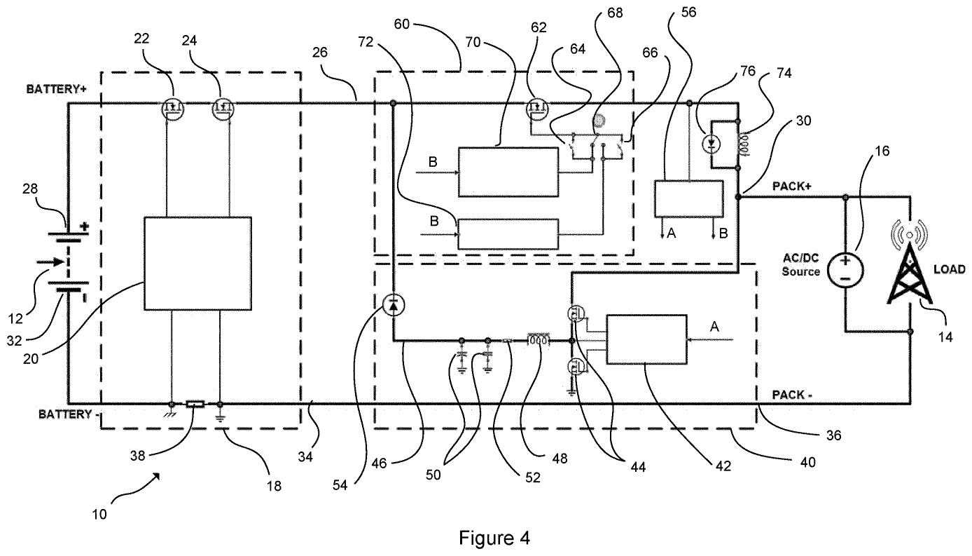

Referring now to FIG. 4, this shows schematically an example of a circuit 10 for providing electrical energy from a rechargeable battery 12 to a load 14 according to an embodiment of the present disclosure. In this example, the battery 12 is providing a back-up in case of loss of power from a power source 16 which is normally powering the load 14. The power source 16 may in general be an AC source (including for example the electricity mains or grid) to a DC source. The power source 16 may be an AC source rectifier which provides DC output to a load or the like. The power source 16 can charge the rechargeable battery 12 in a controlled way in a manner described in detail below. The circuit 10 may be used as part of a battery management circuit system in for example residential or commercial back-up power supplies, at cellular network base stations, network and computer centres, etc.

It should be noted that the circuit 10 shown connected to the load 14 and the power source 16 is for one battery 12. One or more or all of the parts of the circuit 10, that is the parts shown schematically in FIG. 4 other than the battery 12, load 14 and power source 16, may be provided on a single board or electronic card. Plural batteries 12 may be connected in parallel to the load 14 and the power source 16 and each battery 12 has its own similar or identical circuit 10. Further, in examples discussed further below, the circuits 10 may be arranged to permit plural batteries 12 to be connected in series if desired by the end user, whilst still obtaining the benefits provided by the examples of the present disclosure.

The circuit 10 of this example has a battery management system circuit 18 for control of the battery 12. The battery management system circuit 18 is indicated schematically with dashed lines in FIG. 4. Battery management systems are well known in themselves. A battery management system is commonly abbreviated as “BMS”. In general, a battery management system monitors the state of the battery and protects the battery as well as providing for data logging and reports to users and/or external devices.

The main functional blocks of a battery management system comprise a control block 20, which is typically a microcontroller, and a sensing block which is commonly known as the analog front end (“AFE”).

The BMS control block 20 prevents any cell of the battery 12 from going into an overvoltage situation, by stopping charging of the cell; prevents the temperature of any cell of the battery 12 from exceeding a threshold, by reducing or stopping the charging current or by activating a cooling system in the battery pack if present; prevents any cell of the battery 12 going into an under-voltage situation by limiting or stopping the discharge current. The BMS control block 20 also senses the charging and discharging currents and provides protection if an overcurrent situation occurs. Parameters for these situations can often be set manually by a user or set as factory setting considering the cell limit specifications. The AFE is typically provided by an integrated circuit which has inputs to measure the cell voltages of each cell position in the battery and has an in-built temperature sensor which measures the BMS board temperature and uses sense resistors to measure current flowing.

Referring back to FIG. 4, the battery management system circuit 18 is shown having two switches 22, 24. The switches 22, 24 are in series in the power line 26 which passes from a first battery connector 28, to which the positive terminal of the battery 12 is connected in use, to a first load connector 30 to which a terminal of the load 14 is connected in use. It may be noted here that both the terminal of the load 14 and a terminal of the power source 16 are electrically connected to the same load connector 30 and so connect to the same, single, power line 26. For completeness and to close the circuit, there is a second battery connector 32, to which the negative terminal of the battery 12 is connected in use, which is connected by a second power line 34 to a second load connector 36 to which the other terminals of the load 14 and the power source 16 are both electrically connected in use. That is, the load 14 and the power source 16 are connected to the battery 12 by the same lines (being a single line for each of the positive and negative connections).

The switches 22, 24 are operated to control charging of the battery 12 and discharging of the battery 12 (i.e. powering of the load 14). A sensing resistor 38 is located in series in the second power line 14. The BMS control block 20 has electrical connections to the second power line 14 at either side of the sensing resistor 38. In general, the sensing resistor 38 is used by the BMS control block 20 to measure the amount of current which is being discharged by the battery 12 to power the load 14 or which is being received by the battery 12 to charge the battery 12. If any protection state for the battery 12 is triggered for some reason, such as overcurrent in charge mode or overtemperature in discharge mode, this is detected immediately and the BMS control block 20 controls both switches 22, 24 to be in the OFF state.

The switches 22, 24 may be for example N-Channel MOSFETs which are connected back-to-back with a common drain connection. There may be more than two such switches 22, 24 connected in parallel to share the current so that each MOSFET can operate within a safe operating region for the current.

The circuit 10 has an on-board charger circuit 40, indicated schematically with dashed lines in FIG. 4. The principal purpose of the on-board charger circuit 40 is to charge the battery 12 when one or more certain conditions are met, as will be discussed. In an example, the on-board charger circuit 40 is arranged to charge the battery 12 with a constant current, at least initially. This is particularly suitable in the case that the battery 12 is a lithium ion battery. The on-board charger circuit 40 is arranged such that the constant current that is delivered is appropriate for the particular type of battery 12 that is being used with the circuit 10. Especially in the case that the battery 12 is a lithium ion battery, once the battery 12 has reached a predetermined level of charge, the charging may be changed by the on-board charger circuit 40 to be at a constant voltage, such that the charging current decreases over time given that the voltage at the battery 12 increases.

In a specific example, the on-board charger circuit 40 is provided by a synchronous buck converter 40. As is known as such, a synchronous buck converter may be used to step a DC voltage down from a higher level to a lower level. In the present case, the synchronous buck converter 40 is arranged to charge the battery 12 with a constant current at least initially with switching to constant voltage as the battery 12 reaches full charge as discussed above.

In particular, the synchronous buck converter 40 is connected between ground and the first load connector 30 so that the synchronous buck converter 40 can receive electrical energy from the power source 16 when the power source 16 is connected and live. The synchronous buck converter 40 includes a control unit 42, which is typically in the form of an integrated circuit. The control unit 42 controls the operation of two switches 44 which are connected in series in the power line from the first load connector 30 to ground. The switches 44 may be implemented by transistors, such as for example MOSFETs which may be for example N-Channel MOSFETs. The synchronous buck converter 40 may have additional phases so as to be able to provide a larger current to charge the battery 12.

The output to the battery 12 is provided by a charging line 46 which is connected at one end to the junction between the switches 44 and at the other end to the power line 26. An inductor 48 of the buck converter 40 is provided in the charging line 46. One or more output capacitors 50 of the buck converter 40 are connected between the charging line 46 and ground. As is known as such, the current in the inductor 48, which is output to charge the output capacitors 50 which then charge the battery 12, is controlled by the two switches 44. A sensing resistor 52 is provided in series with the inductor 48 and provides a measure of the instantaneous current that is flowing to the control unit 42 of the buck converter 40. Based on the measured current, the control unit 42 outputs control signals to control the switching of the switches 44 so that the desired constant current is delivered by the buck converter 40 to charge the battery 12, at least initially. Once the battery 12 has reached a predetermined level of charge, the control unit 42 outputs control signals to control the switching of the switches 44 so that the charging is at a constant voltage, such that the charging current decreases over time given that the voltage at the battery 12 increases. Further, in the example shown, a diode 54 is provided in the charging line between the output of the capacitors 50 and the power line 26 so that current can only flow from the buck converter 40 to the battery 12 (to charge the battery 12) and current cannot flow from the battery 12 to the buck converter 40 when the battery 12 is being used to power the load 14

The on-board charger circuit 40, implemented here as a buck converter 40, is only enabled to charge the battery 12 if one or more predetermined conditions are met. The circuit 10 includes a voltage control circuit 56 to control operation of the on-board charger circuit 40 and specially to control whether the on-board charger circuit 40 charges the battery 12 or not. The voltage control circuit 56 is electrically connected to the first load connector 30 and the second load connector 36 to be able to measure the voltage difference between the first load connector 30 (indicated as PACK+ in FIG. 4) and the second load connector 36 (indicated as PACK− in FIG. 4). Depending on the value of this voltage difference, the voltage control circuit 56 outputs or not an enable signal A to an enable pin of the control unit 42 of the on-board charger circuit 40 which respectively enables or not the on-board charger circuit 40 to charge the battery 12. In particular, the voltage control circuit 56 compares the voltage difference of the voltages PACK+ and PACK− with a threshold. If that voltage difference is greater than a predetermined threshold (or greater than or equal to the predetermined threshold), then the voltage control circuit 56 outputs the enable signal A to the control unit 42 of the on-board charger circuit 40 so that the on-board charger circuit 40 then operates to charge the battery 12. Otherwise, if the measured voltage is less than the threshold, then the enable signal A is not output by the voltage control circuit 56 and the on-board charger circuit 40 is not operate to charge the battery 12.

The threshold that is used by the voltage control circuit 56 to decide whether or not to output the enable signal A is set based on the expected output voltage of the battery 12 and the expected voltage of the power source 16, at least when the power source 16 is working correctly. Consider the following, realistic, example.

Assume for example that the battery 12 has 15 serial and 1 parallel connected lithium iron phosphate (LiFePO₄) (also known as lithium ferro phosphate (LFP)) battery cells. Given the that the individual LiFePO₄ cells have a nominal voltage of 3.2 volts, the nominal output voltage of the battery 12 is around 48V. In practice, considering the typical under and over single cell voltages limit, the battery 12 outputs a voltage in the interval between 43V-54.5V. Assume also that the power source 16 is set to always output a constant voltage with a value greater than the output voltage of the battery pack, such as for example 56V. Assume that the voltage control circuit 56 uses the expected output voltage of 56V of the power source 16 as the threshold. Then, if the voltage difference between PACK+ and PACK− is equal to or greater than 56V, it can be assumed that the power source 16 is operating correctly (to power the load 14) and therefore the on-board charger circuit 40 can be enabled by the voltage control circuit 56 to charge the battery 12, from the power source 16. On the other hand, if the voltage difference between PACK+ and PACK− is less than 56V, it can be assumed that the power source 16 is not operating correctly (and has possibly disconnected or failed completely). In that case, the voltage control circuit 56 does not output the enable signal to the on-board charger circuit 40 and the on-board charger circuit 40 is not used to charge the battery 12. It may be noted that the voltage control circuit 56 may still detect a voltage difference between PACK+ and PACK− because for example the battery 12 is providing back-up power to the load 14 as the power source 16 has failed.

In summary so far, the circuit 10 has its own on-board charger circuit 40 which is used to charge the battery 12 from the power source 16 if it is determined that a sufficient voltage from the power source 16 is available. When there are plural batteries 12, for example to provide increased capacity as a back-up to power the load 14 in case of loss of power from the mains grid, each battery 12 has its own circuit 10. Further, the on-board charger circuit 40 is only operated to charge the battery 12 if the voltage difference between PACK+ and PACK− is equal to or greater than the maximum output voltage of the batteries 12 (e.g. if voltage difference between PACK+ and PACK− is equal to or greater than 56V, where the maximum output voltage of the batteries 12 might be 54.5V). There is no need to provide separate connections for the load 14 and the power source 16.

Referring back to FIG. 4, the circuit 10 of this example provides additional options for the user which the user can select according to the particular application of the circuit 10 and the parts being used. In particular, indicated schematically with dashed lines in FIG. 4 at 60 is a selection circuit 60 which allows selection of charging to be only by the on-board charger circuit 40 or to be by the on-board charger circuit 40 or a different charging source (such as the power source 16 which may be an AC source rectifier which provides DC output), depending on the system requirements.

The selection circuit 60 includes a switch 62 in the power line 26, which can be operated to allow current to flow or not along the power line 26, and which can in particular be operated to allow current to flow in only one direction along the power line 26 or in either direction along the power line 26. In the example shown, the switch 62 is as MOSFET, such as for example an N-channel MOSFET. As known, a MOSFET includes a parallel diode. In this case, the parallel diode of the MOSFET switch 62 always allows current to flow from the battery 12 to the load 14 to allow the battery 12 always to discharge to the load 14. The MOSFET of the MOSFET switch 62 can be opened to prevent current flowing along the power line 26 to the battery 12 and which can be closed to allow current flowing along the power line 26 the battery 12. The selection circuit 60 has at least two jumpers 64, 66 or a toggle switch 68, and, for maximum flexibility for the user, has both two jumpers 64, 66 and a toggle switch 68. The jumpers 64, 66 and toggle switch 68 provide a connection between the switch 62 in the power line 26 and two switching circuits 70, 72 to enable selection of which of the two switching circuits 70, 72 controls operation of the switch 62 in the power line 26.

In particular, a first switching circuit 70 can be enabled by closing the first jumper 64 and opening the second jumper 66, which makes a connection between the first switching circuit 70 and the switch 62 in the power line 26. This can be carried out during manufacture of the circuit 10 or in the field by an end user. Alternatively, if a toggle switch 68 is provided, this can be operated by the user to make a connection between the first switching circuit 70 and the switch 62 in the power line 26. In such a case, if jumpers 64, 66 are provided, these are both left open. Either way, whether using the jumpers 64, 66 or the toggle switch 68, this may be referred to as “position 1”.

In this example, the first switching circuit 70 operates to allow current to flow in both directions along the power line 26 via the switch 62. That is, current can flow from the battery 12 to power the load 14 when needed, and current can flow from the power source 16, or indeed from some other power source, to charge the battery 12 when needed. Such charging via the switch 62 may be at for example constant current, if for example the power source 16 or other power source connected via the switch 62 delivers power at a constant current. Note that such charging is available as an option in addition to the charging available via the on-board charger circuit 40, as will be explained further below.

On the other hand, the second switching circuit 72 can be enabled by opening the first jumper 64 and closing the second jumper 66, which makes a connection between the second switching circuit 72 and the switch 62 in the power line 26. Again, this can be carried out during manufacture of the circuit 10 or in the field by an end user. Alternatively, again, if a toggle switch 68 is provided, this can be operated by the user to make a connection between the second switching circuit 72 and the switch 62 in the power line 26. In such a case, if jumpers 64, 66 are provided, these are both left open. Either way, again whether using the jumpers 64, 66 or the toggle switch 68, this may be referred to as “position 2”.

In this example, the second switching circuit 72 operates to allow current to flow only in one direction along the power line 26 via the switch 62, namely from the battery 12 to the load 14. That is, current can flow from the battery 12 to power the load 14 when needed. On the other hand, current to charge the battery 12 can only be available by the on-board charger circuit 40 as discussed above.

The first switching circuit 70 may be implemented by for example a high side FET driver circuit, which, when enabled when the jumpers 64, 66 or the toggle switch 68 are at position 1, allows current to flow in both directions. The second switching circuit 72 may be implemented by for example an ideal diode controller circuit, which, when enabled when the jumpers 64, 66 or the toggle switch 68 are at position 2, allows current to flow in one direction only, from the battery 12 to the load 14 (discharging only) and blocks current flow in the opposite direction. Switching circuits of this type, including in particular high side FET driver circuits and ideal diode controller circuits, are well known in themselves.

As discussed in more detail above, if the voltage difference of the voltages PACK+ and PACK− is greater than (or equal to) a threshold, then the enable signal A is output by the voltage control circuit 56 to the control unit 42 of the on-board charger circuit 40 so that the on-board charger circuit 40 then operates to charge the battery 12. In the example that includes the first switching circuit 70 and the second switching circuit 72, either of which can be freely selected by the user depending on the particular implementation, then the voltage control circuit 56 is arranged to output an enable signal B to enable operation of the first switching circuit 70 and the second switching circuit 72 respectively. The conditions that cause the voltage control circuit 56 to output enable signal B are set according to the particular implementation.

For example and continuing the example above where the battery is a lithium ion battery, the power source 16 is set to always output a constant voltage with a value greater than the output voltage of the battery pack, such as for example 56V. The voltage control circuit 56 is arranged such that if the voltage difference between PACK+ and PACK− is equal to or greater than 56V, then the enable signal A is output by the voltage control circuit 56 to the control unit 42 of the on-board charger circuit 40 so that the on-board charger circuit 40 then operates to charge the battery 12. It may be noted that in this case when the voltage difference between PACK+ and PACK− is equal to or greater than the set threshold (here 56V), it does not matter which of the first switching circuit 70 and the second switching circuit 72 has been selected (using the jumpers 64, 66 or toggle switch 68 at position 1 or position 2 respectively as discussed above) as only the on-board charger circuit 40 is enabled. On the other hand, the voltage control circuit 56 is arranged such that if the voltage difference between PACK+ and PACK− is equal to or less than 54.5V (the maximum expect operating voltage of the battery 12), in this example the voltage control circuit 56 outputs the enable signal B, which is received at the first switching circuit 70 and the second switching circuit 72. This causes whichever of the first switching circuit 70 and the second switching circuit 72 has been selected (using the jumpers 64, 66 or toggle switch 68 at position 1 or position 2 respectively as discussed above) to operate to control the switch 62 in the power line 26 as discussed in more detail above (in brief, to allow current flow only from the battery 12 to the load 14 via the switch 62 or from the battery 12 to the load 14 and from the power source 16 to the battery 12 via the switch 62).

This operation of the voltage control circuit 56 can be implemented as, or at least visualised by, the following truth table:

| Voltage between PACK+ | | |
|---|---|---|
| and PACK− | Enable A | Enable B |
| Vpack < 43 V | LOW | HIGH |
| 43 V ≤ Vpack ≤ 54.5 V | LOW | HIGH |
| 54.5 < Vpack < 56 V | Noise Margin | Noise Margin |
| Vpack ≥ 56 V | HIGH | LOW |

Here, “HIGH” means that the relevant enable signal is output, with for example a voltage of 5V, and “LOW” means that the relevant enable signal is not output, the enable output voltage being for example 0V.

As can be seen, if the voltage difference between PACK+ and PACK− is greater than 56V, then Enable A is output and Enable B is not output, which causes the on-board charger circuit 40 to charge the battery 12. Further, as noted above because of the typical under and over single cell voltages limit, the battery 12 typically outputs a voltage in the interval between 43V-54.5V. Therefore, if the voltage difference between PACK+ and PACK− is in this range 43V-54.5V or is less than 43V, then Enable B is output and Enable A is not output. This causes operation of whichever of the first switching circuit 70 and the second switching circuit 72 has been selected according to whether the jumpers 64, 66 or the toggle switch 68 are at position 1 or position 2, allowing charging or not by the power source 16 other than via the on-board charger circuit 40.

In the truth table, there is a region where 54.5<Vpack<56V. This is regarded as a “noise margin” given that tolerances of components means that voltages, etc. can vary in practice. The voltage control circuit 56 may be arranged to cause discharge from the battery 12 or allow charging of the battery 12 in this region, depending on the specific values of the components concerned.

A particular advantage of providing the selection circuit 60 is that it allows users more flexibility in the field, when the circuit 10 is in actual use. For example, in practice, it is common for lead acid batteries to be used, in for example back-up power supplies, including at for example cellular base stations to power the electronics and antenna, etc. in the case of mains power loss. The lifetime of such lead acid batteries is relatively short (e.g. 2 to 3 years in practice) and gradually they are being replaced in the field with lithium ion batteries. However, in practice, this means that there may be a mixture of lead acid batteries and lithium ion batteries in use at one time at a particular installation, powering the same load 14 in a parallel connection.

In such a case, the user can set the jumpers 64, 66 or the toggle switch 68 to position 2. To understand the significance of this, assume that there has been a loss of mains power, such that the lead acid batteries and the lithium ion batteries have been discharging to provide back-up power. Assume further that mains power is then restored. To recharge the lead acid batteries, a large current can be provided by the power source 16, such as a rectifier which provides DC output, as this can be accommodated by the lead acid batteries which do not normally have any overcurrent protection circuitry. To provide a large current, the output voltage of the power source 16 is set relatively low and, in particular, is lower than the maximum threshold used by the voltage control circuit 56 (following the example above, the output voltage of the power source 16 is for example set at 48V where the maximum threshold is 56V). Because position 2 has been selected, the second switching circuit 72 has been selected. This means that using the circuit 10 with a lithium ion battery 12 installed, the battery 12 is protected against the large current being delivered by the power source 16 to other batteries in the system. This is because the second switching circuit 72 is enabled by the Enable B signal and operates the switch 62 to prevent current passing from the power source 16 to the battery 12; and further because the output voltage of the power source 16 is lower than the maximum threshold used by the voltage control circuit 56, the Enable A is not output and therefore the on-board charger circuit 40 is also not delivering a large current to the battery 12.

In short, this allows a mixture of lead acid batteries and lithium ion batteries to be used in parallel, and allows large currents to be provided to recharge the lead acid batteries whilst protecting the lithium ion batteries against large charging currents. Once the lead acid batteries have charged, the output voltage of the power source 16 increases and can reach the maximum threshold, which means that the Enable A signal is output by the voltage control circuit 56, allowing the on-board charger circuit 40 to charge the lithium ion battery 12. Notably, this is achieved without the need for software control for switching the outputs of the batteries for equalization of the outputs or switching the outputs of the batteries with control sequences or signals, and avoids the need for communication between the batteries.

In the example shown, the circuit 10 has an inductor 74 in the power line 26 between the voltage control circuit 56 and the first load connector 30. A diode 76, which is for example a Schottky diode, is located in parallel with the inductor 74 in the power line 26. The combination of the inductor 74 and the diode 76 allow the voltage control circuit 56 to detect the voltage coming from the power source 16 properly. In particular, when a power source 16 is energised and current starts to flow, the voltage can drop practically immediately. This is particular the case for high currents, such as 50 amps or more, which have more of a tendency to cause voltage drops when the current starts to flow. The inductor 74 allows the voltage control circuit 56 enough time to detect the voltage before the voltage drops. The diode 76 protects the power source 16 from an instantaneous voltage increase which can be caused by an on/off state transition of the inductor 74.

Returning to the voltage control circuit 56, for speed of operation, it is preferred that this is implemented not using software or an integrated circuit, including an application-specific integrated circuit (ASIC) and a field-programmable gate array (FPGA). In a specific example of the present disclosure, the voltage control circuit 56 is implemented as a comparator circuit using transistor shunt regulators. The voltage control circuit 56 may only require transistors, which are operated as adjustable Zener diodes, transistor switches, one or more resistors, one or more diodes and one or more capacitors. No integrated circuit or software or the like is required.

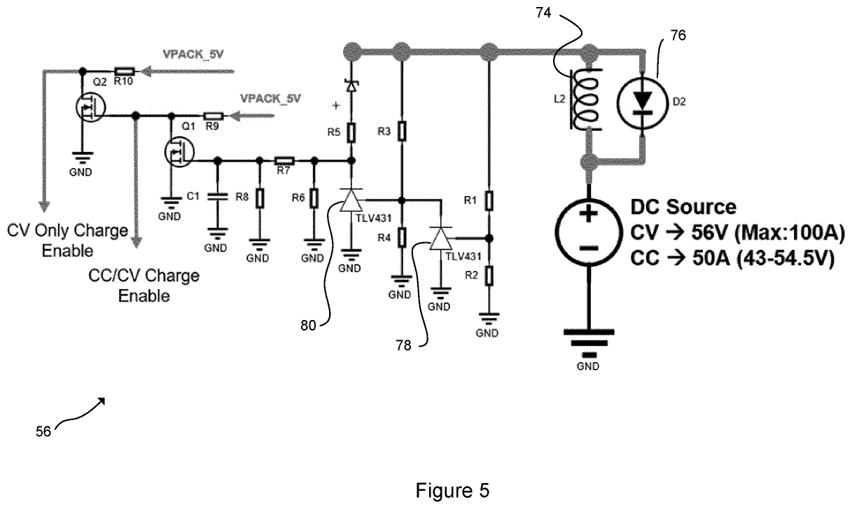

In particular, referring to FIG. 5, this shows schematically a specific example of a voltage control circuit 54 of the circuit 10 of FIG. 4. It will be understood that not all of the resistors, diodes, etc. may be required in all examples, and that other examples may have different arrangements of resistors, diodes, etc. and achieve the same functionality. The principal function is to compare the voltage difference between the first load connector 30 (indicated as PACK+ in FIG. 4) and the second load connector 36 (indicated as PACK− in FIG. 4) with a threshold and, depending on the value of this voltage difference, output the appropriate enable signals Enable A and Enable B accordingly.

In FIG. 5, the inductor marked L2 corresponds to the inductor 74 of FIG. 4, and the diode marked D2 corresponds to the diode 76 of FIG. 4. The output marked “CV Only Charge Enable” corresponds to the Enable A signal and the output marked “CC/CV Charge Enable” corresponds to the Enable B signal. The transistors of the shunt regulators of the voltage control circuit 54 are indicated at 78 and 80. The voltage levels for the thresholds, examples of which are indicated in the truth table above, are determined by the various resistors R1, R2, R3, R4, R5, R6, R7, R8 shown in FIG. 5 which are arranged in series and in parallel as voltage dividers in a manner known as such.

In this particular example, if for example the pack voltage, which is parallel connected to the DC source, is between 43V-54.5V, then the transistor marked Q1 is OFF and the transistor marked Q2 is ON, which means that CC/CV Charge (Enable B) is enabled and CV Only Charge (Enable A) is disabled. Charging via the on-board charger circuit 40, for example the buck converter 40, is prevented.

On the other hand, if for example the pack voltage is equal to or greater than 56V, then the transistor marked Q2 is OFF and the transistor marked Q1 is ON, which means that CC/CV Charge (Enable B) is disabled and CV Only Charge (Enable A) is enabled. Charging via the on-board charger circuit 40, for example the buck converter 40, can be carried out as discussed above.

In a working example, it has been found that the voltage control circuit 56 can switch to allow discharge of the battery 12 to power the load 14 within around 400 microseconds. This is extremely fast, and provides for a robust back-up power supply which can be used to power loads that can only tolerate power drop outs of very short duration.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A circuit for providing electrical energy from a rechargeable battery connected in use to the circuit to a load connected in use to the circuit and for controlling charging of the rechargeable battery, the circuit comprising:
a first battery connector for electrical connection to a first terminal of a rechargeable battery connected in use to the circuit;
a second battery connector for electrical connection to a second terminal of said rechargeable battery;
a first load connector for electrical connection to a first terminal of a load connected in use to the circuit and to a first terminal of a source of electrical energy connected in use to the circuit;
a second load connector for electrical connection to a second terminal of said load and to a second terminal of said source of electrical energy;
whereby said load and said source of electrical energy are connected to the same load connectors of the circuit;
a charger circuit for receiving electrical energy from said source of electrical energy and outputting the electrical energy to charge said rechargeable battery;
a voltage control circuit constructed and arranged to control operation of the charger circuit by comparing a voltage difference between the first load connector and the second load connector with a threshold, wherein the voltage control circuit is constructed and arranged to control the charger circuit to operate to output electrical energy to charge said rechargeable battery if the voltage difference between the first load connector and the second load connector is greater than the threshold, and wherein the voltage control circuit is constructed and arranged to control the charger circuit not to output electrical energy to charge said rechargeable battery if the voltage difference between the first load connector and the second load connector is less than the threshold.

2. A circuit according to claim 1, comprising a switch in the discharge path from said rechargeable battery to one of the load connectors to control discharge of said rechargeable battery to said load and charging of said rechargeable battery, wherein the voltage control circuit is constructed and arranged such that if the voltage difference between the first load connector and the second load connector is less than the threshold, the voltage control circuit causes the switch to be operated either (i) to allow discharge of said rechargeable battery to said load and to allow charging of said rechargeable battery by said source of electrical energy via the switch or (ii) to allow discharge of said rechargeable battery to said load and to block charging of said rechargeable battery by said source of electrical energy via the switch.

3. A circuit according to claim 2, wherein the switch is an N-channel MOSFET, and comprising a high side FET drive circuit which is enabled by the voltage control circuit to operate the N-channel MOSFET to allow discharge of said rechargeable battery to said load and to allow charging of said rechargeable battery by said source of electrical energy via the N-channel MOSFET when the voltage difference between the first load connector and the second load connector is less than the threshold.

4. A circuit according to claim 2, wherein the switch is an N-channel MOSFET, and comprising an ideal diode controller which is enabled by the voltage control circuit to operate the N-channel MOSFET to allow discharge of said rechargeable battery to said load and to block charging of said rechargeable battery by said source of electrical energy via the N-channel MOSFET.

5. A circuit according to claim 3, comprising at least one of a toggle switch and jumpers which can be operated to select whether the voltage control circuit enables the high side FET drive circuit or the ideal diode controller to operate the N-channel MOSFET when the voltage difference between the first load connector and the second load connector is less than the threshold.

6. A circuit according to claim 2, wherein the voltage control circuit comprises a comparator circuit which comprises two transistor shunt regulators, the transistor shunt regulators being constructed and arranged to output enable signals to control operation of the charger circuit and the switch in the discharge path from said rechargeable battery to said load.

7. A circuit according to claim 1, wherein the charger circuit is connected to said rechargeable battery via a diode which permits electrical energy to pass from the charger circuit to said rechargeable battery to allow said rechargeable battery to be charged by the charger circuit and which prevents electrical energy passing from said rechargeable battery to the charger circuit when said rechargeable battery is discharging.

8. A circuit according to claim 1, wherein the charger circuit is a synchronous buck converter which is arranged to receive electrical energy from said source of electrical energy at a first voltage and output the electrical energy at a second voltage to charge said rechargeable battery.

9. A circuit according to claim 1, comprising a battery management control unit for control of said rechargeable battery, wherein the electrical connections of the circuit to the first and second terminals of said rechargeable battery are via the battery management control unit.
